(19) United States
(12) Patent Application Publication
(10) Pub. No.: US 2015/0073707 A1
(43) Pub. Date: Mar. 12, 2015

(54) SYSTEMS AND METHODS FOR COMPARING RANGE DATA WITH EVIDENCE GRIDS

(71) Applicant: Honeywell International Inc., Morristown, NJ (US)

(72) Inventors: Yunqian Ma, Plymouth, MN (US); Gang Qian, Chandler, AZ (US); John B. McKitterick, Columbia, MD (US)

(73) Assignee: Honeywell International Inc., Morristown, NJ (US)

(21) Appl. No.: 14/021,254

(22) Filed: Sep. 9, 2013

(51) Int. Cl. G01C 21/16; G01S 17/93; G01S 13/93

(52) U.S. Cl. CPC G01C 21/165; G01S 13/9303; G01S 17/933
USPC 701/501

(57) ABSTRACT

Systems and methods for comparing range data with evidence grids are provided. In certain embodiments, a system comprises an inertial measurement unit configured to provide inertial measurements; and a sensor configured to provide range detections based on scans of an environment containing the navigation system. The system further comprises a navigation processor configured to provide a navigation solution, wherein the navigation processor is coupled to receive the inertial measurements from the inertial measurement unit and the range measurements from the sensor, wherein computer readable instructions direct the navigation processor to identify a portion of an evidence grid based on the navigation solution; compare the range detections with the portion of the evidence grid; and calculate adjustments to the navigation solution based on the comparison of the range detections with the portion of the evidence grid to compensate for errors in the inertial measurement unit.

### BACKGROUND

Landing a vehicle in a degraded visual environment (DVE) such as a brownout is a dangerous and a stressful situation for a pilot. The lack of visual cues makes it extremely difficult to maintain the correct orientation of the aircraft, and the loss of visibility may cause a loss of situational awareness. When situational awareness is lost, wire strikes, collisions with other aircraft, and hard landings may result. In certain implementations, situational awareness may be provided to a pilot through a synthetic vision system. The synthetic vision system may use radar or LiDAR to provide a pilot with a real-time image of the scene both in the landing zone as well as at the horizon. In certain implementations, the real-time image may be a map created through the use of an evidence grid.

In certain applications, a priori terrain data, such as digital terrain elevation data, is used with the synthetic vision system. To use a priori terrain data in conjunction with the synthetic vision system, the raw radar or LiDAR data may be aligned with the a priori data to create a coherent unified scene that a pilot may use to navigate in the DVE. However, the a priori data may not contain all of the features in the scene. For example, the a priori data may contain bare earth data or be out of date. When a GPS signal is unavailable and there are buildings in the scene, which are not in the a priori data, then a lateral drift in navigation may not be detected nor compensated. As a result, the evidence grid, on which the pilot's display may be based, may appear to have a moving or disappearing building. When landing in a DVE, moving and/or disappearing building may pose a significant threat to the safety of the pilot.

### SUMMARY

Systems and methods for comparing range data with evidence grids are provided. In certain embodiments, a system comprises an inertial measurement unit configured to provide inertial measurements; and a sensor configured to provide range detections based on scans of an environment containing the navigation system. The system further comprises a navigation processor configured to provide a navigation solution, wherein the navigation processor is coupled to receive the inertial measurements from the inertial measurement unit and the range measurements from the sensor, wherein computer readable instructions direct the navigation processor to identify a portion of an evidence grid based on the navigation solution; compare the range detections with the portion of the evidence grid; and calculate adjustments to the navigation solution based on the comparison of the range detections with the portion of the evidence grid to compensate for errors in the inertial measurement unit.

### DRAWINGS

Understanding that the drawings depict only exemplary embodiments and are not therefore to be considered limiting in scope, the exemplary embodiments will be described with additional specificity and detail through the use of the accompanying drawings, in which:

FIG. 1 is a block diagram illustrating the functions performed by a navigation processor when comparing an evidence grid to range data received from a sensor in one embodiment described in the present disclosure;

FIG. 2 is a graph illustrating the comparison of a beam of range data to an evidence grid in one embodiment described in the present disclosure;

FIG. 3 is a block diagram illustrating the functions performed by a navigation processor when adjusting the identified position of a sensor in one embodiment described in the present disclosure;

FIG. 4 is a graph illustrating the adjustment of an identified position for a sensor in one embodiment described in the present disclosure; and

FIG. 5 is a flow diagram of a method for comparing an evidence grid to range data received from a sensor in one embodiment described in the present disclosure.

In accordance with common practice, the various described features are not drawn to scale but are drawn to emphasize specific features relevant to the exemplary embodiments.

### DETAILED DESCRIPTION

In the following detailed description, reference is made to the accompanying drawings that form a part hereof, and in which is shown by way of illustration specific illustrative embodiments. However, it is to be understood that other embodiments may be utilized and that logical, mechanical, and electrical changes may be made. Furthermore, the method presented in the drawing figures and the specification is not to be construed as limiting the order in which the individual steps may be performed. The following detailed description is, therefore, not to be taken in a limiting sense.

Systems and methods are provided for comparing range data with evidence grid data. To compare the range data with evidence grid data, a navigation processor evaluates a cost function that measures the consistency of three-dimensional occupancy between a raw range data frame and an evidence grid. In particular, a nonlinear cost function is reduced over the navigation solution. For example, the navigation processor may reduce a cost function that is the sum of the squared matching errors over all the ranging beams used to produce the raw range data frame. For each ranging beam, the matching error is defined as one less the maximum probability of occupancy in a cubic neighborhood centered at the location of the surface detected by the ranging beam. In one implementation the matching errors may be pre-computed for the possible locations of beam detection and then the matching error may be stored in a hash table where they are easily accessed.

In certain embodiments, the navigation processor reduces the cost function by pre-computing the matching errors for the locations of range detection inside the EG and storing the matching errors in a hash table. The navigation processor uses the matching error table and an initial navigation solution to compute a matching error vector that is based on the matching errors from the ranging beams and the Jacobian matrix of the matching error vector with respect to the navigation solution. The navigation processor then computes a correction to the navigation solution by solving a normal equation based on the Jacobian matrix and the matching error vector and then adds the resulting navigation correction vector to the initial navigation solution to update the navigation solution. Further, the corrected navigation solution may then be used to initialize a subsequent iteration until a stopping criteria is achieved, such as a matching error vector is less than a threshold. By performing the above process, the navigation processor is able to directly compare a range data frame and an evidence grid to provide adjustments to a navigation solution.

In certain implementations, the range data and the evidence grid may be compared to initialize the position of a sensor providing the ranging beams. The position initialization aids in overcoming navigation errors that may cause the raw range data and the evidence grid to not overlap. To reduce the initial navigation errors, this invention first computes an adjustment to the identified position of the sensor along the normal of the dominant 3D surface structure represented by the evidence grid. The adjustment to the identified position is then added to the identified position of the sensor such that the raw range data frame and the evidence grid are roughly aligned with each other.

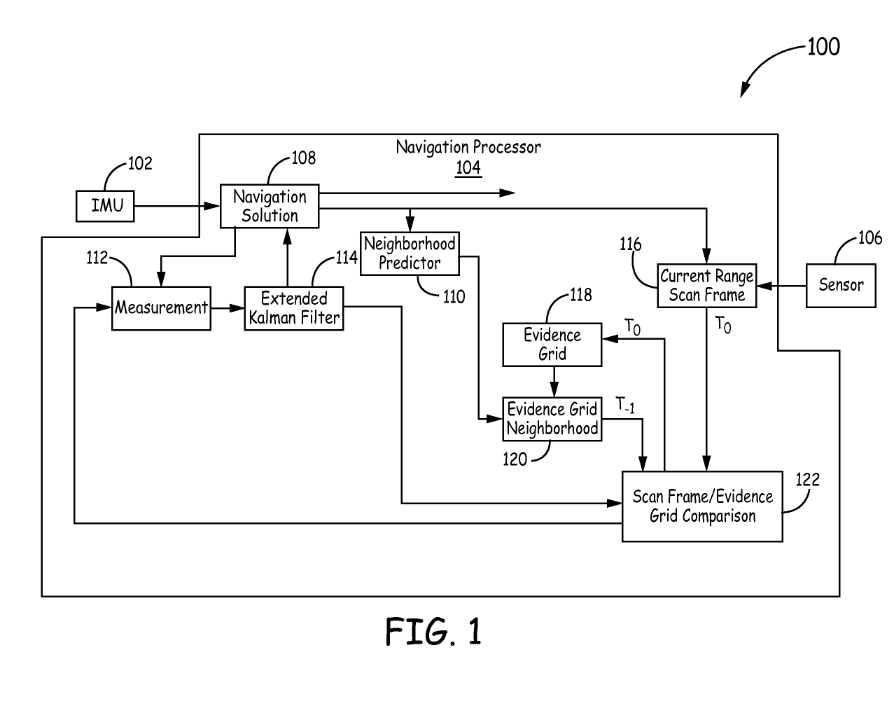

FIG. 1 is a diagram of an exemplary navigation system 100 for comparing range data to evidence grids to ensure the accuracy of a navigation solution. In one implementation, navigation system 100 comprises an IMU 102 that outputs one or more channels of inertial motion data to a navigation processor 104, where the navigation processor 104 executes computer readable instructions that direct the navigation processor 104 to compare range data to evidence grids while providing a navigation solution 108. Navigation system 100 further comprises a Kalman filter 114 which supplies correction data that the Navigation processor 104 uses to adjust the navigation solution 108. In certain implementations, the correction data may be derived from the comparison of range data to an evidence grid, as further discussed below.

The IMU 102 may be a combination of sensor devices that are configured to sense motion and output data corresponding to the sensed motion. In one embodiment, IMU 102 comprises a set of 3-axis gyroscopes and accelerometers that determine information about motion in any of six degrees of freedom (that is, lateral motion in three perpendicular axes and rotation about three perpendicular axes).

The phrase “navigation processor,” as used herein, generally refers to an apparatus for calculating a navigation solution by processing the motion information received from IMU 102 and other sources of navigation data. As used herein, a navigation solution contains information about the position, velocity, and attitude of the object at a particular time. Further, the navigation processor 104 may be implemented through digital computer systems, microprocessors, general purpose computers, programmable controllers and field programmable gate arrays (FPGAs) or application-specific integrated circuits (ASICs). The navigation processor 104 executes program instructions that are resident on computer readable media which when executed by the navigation processor 104 cause the navigation processor 104 to implement embodiments described in the present disclosure. Computer readable media include any form of a physical computer memory storage device. Examples of such a physical computer memory device include, but is not limited to, punch cards, magnetic disks or tapes, optical data storage systems, flash read only memory (ROM), non-volatile ROM, programmable ROM (PROM), erasable-programmable ROM (E-PROM), random access memory (RAM), or any other form of permanent, semi-permanent, or temporary memory storage system or device. Program instructions include, but are not limited to computer-executable instructions executed by computer system processors and hardware description languages such as Very High Speed Integrated Circuit (VHSIC) Hardware Description Language (VHDL).

In one embodiment, in operation, IMU 102 senses inertial changes in motion and transmits the inertial motion information as a signal or a plurality of signals to a navigation processor 104. In one example, navigation processor 104 applies dead reckoning calculations to the inertial motion information to calculate and output the navigation solution. In another example, navigation processor 104 uses differential equations that describe the navigation state of IMU 102 based on the sensed accelerations and rates available from accelerometers and gyroscopes respectively. Navigation processor 104 then integrates the differential equations to develop a navigation solution. During operation of IMU 102, errors arise in the movement information transmitted from IMU 102 to navigation processor 104. For example, errors may arise due to misalignment, non-orthogonality, scale factor errors, asymmetry, noise, and the like. As navigation processor 104 uses the process of integration to calculate the navigation solution, the effect of the errors received from IMU 102 accumulate and cause the accuracy of the reported navigation solution to drift away from the object's actual position, velocity, and attitude. To correct errors and prevent the further accumulation of errors, navigation processor 104 receives correction data from Kalman filter 114. The inputs to Kalman filter 114 are derived from the calculated navigation solution 108 and a navigation solution update 122 calculated based on the comparison of a current range scan frame 116 and an evidence grid 118, where the navigation solution update 122 includes an estimate of the position and attitude of the vehicle in relation to the sensed environment.

In the embodiment shown in FIG. 1, when the navigation processor 104 compares the current range scan frame 116 to an evidence grid 118, the navigation processor 104 first receives measurements from a sensor 106 to create the current range scan frame 116. The term “sensor,” as used herein, refers to sensors that are able to return range data that describes objects in an environment of the navigation system 100. In certain implementations, sensor 106 actively senses its environment by emitting and receiving energy, such as, by using light detection and ranging (LIDAR), RADAR, SONAR, ultrasonic acoustics, and the like to measure the range and angles from sensor 106 to objects in the environment. Alternatively, in other embodiments, sensor 106 passively senses the environment such as by using a stereoscopic camera or other device that receives ambient energy from the environment and determines the range and angles from sensor 106 to objects in the environment. Sensor 106 scans the environment to gather information about features that exist in the environment for a determined period of time. Scans can comprise a single full scan of the environment or comprise multiple scans of the environment collected over several seconds. In at least one implementation, the sensor 106 provides multiple beams, where the sensor 106 provides a range measurement at a known azimuth and elevation for each beam when the beam detects an object. The current range scan frame 116 is the current frame of data that was provided by the sensor 106.

In certain implementations, the navigation processor 104 compares the current range scan frame 116 against an evidence grid 118 of historical data. As used herein, an evidence grid is a two or three dimensional matrix of cells (or voxels) where, in at least one embodiment, the cells are marked as either occupied or unoccupied to represent physical features in an environment. In certain embodiments, the cells are marked with a probability of occupancy by a physical feature in the environment. In at least one implementation, the evidence grid 118 may be created from historical range scan frames received from the sensor 106. In conjunction with the historical data received from the sensor 106, the evidence grid 118 may also be initially created from a terrain model such as digital terrain elevation data (DTED) or high-resolution Buckeye data.

The evidence grid 118 illustrates the relative position of features and terrain in relation to the navigation system 100's reference frame as occupied voxels. In at least one implementation, binary encoding is used to indicate whether a voxel is or is not occupied. For example, a zero would indicate that the cell is empty of a feature while a one would indicate that the cell is occupied by a feature. Alternately, the method used to indicate which voxels are occupied is based on a probabilistic encoding. That is, for each cell a probability value is assigned that indicates the probability that the cell is occupied by a feature. In still other embodiments, a combination of binary and probabalistic encoding is utilized.

As would be appreciated by one of ordinary skill in the art upon reading this specification, the decision as to whether to use a binary encoding or a probabilistic encoding depends on the application and processing abilities of navigation system 100 in FIG. 1. For example, probabilistic encoding, while more accurately representing an environment than binary encoding, requires more memory and faster processors than binary encoding. Therefore, in a navigation system 100 that needs higher accuracy, an evidence grid stores data about features with a probabilistic encoding. Conversely, in a navigation system where the processing and memory are limited or faster processing speed is desired, an evidence grid stores data about features with a binary encoding. In a further embodiment, the size of the volume associated with the voxel may determine whether a navigation system encodes the positions of features with a binary encoding or a probabilistic encoding. Where the volume size is large, a navigation system encodes the position of features with a probabilistic encoding. Equally, where the volume size is small, a navigation system encodes the position of features within an evidence grid using a binary encoding.

As the evidence grid 118 may represent a large area, in certain embodiments, the concept of an evidence grid neighborhood 120 is introduced. Utilizing an evidence grid neighborhood 120 restricts the comparison of the current range scan frame to a limited area within the evidence grid 118 or a specific portion of the evidence grid located around the navigation solution 108. To identify the evidence grid neighborhood 120, a region defined by a neighborhood predictor 110 that uses the navigation solution 108 with a probability space encompassing the possible errors that are introduced into the navigation solution by the IMU 102. Using the navigation solution, and the probability space of possible errors, neighborhood predictor 110 identifies a neighborhood of voxels within the evidence grid 118 that can possibly be associated with the environment scanned by the sensor 106. By identifying the evidence grid neighborhood 120, the navigation processor 104 compares the current range scan frame 116 against a limited area represented within the evidence grid 118. By limiting the comparison area associated with the evidence grid 118 to that area represented by the evidence grid neighborhood 120, the navigation processor 104 may more quickly compare the current range scan frame 116 against the data stored in the evidence grid 118.

In at least one embodiment, in the comparison of the current range scan frame 116 against the evidence grid 118, the navigation processor performs scan frame/evidence grid (SF/EG) comparison 122. The SF/EG comparison 122 produces a navigation solution update that is provided to measurement 112 and used to update the navigation solution 108. In at least one implementation, when comparing the current range scan frame 116 against the evidence grid 118 (or evidence grid neighborhood 120, as discussed above), the navigation processor 104 evaluates a matching cost function. For example, the navigation processor 104 reduces a nonlinear cost function that is the sum of the squared matching errors for the returns from the ranging beams in sensor 106. As described in greater detail below, for each ranging beam used by the sensor 106 to scan an environment, the matching error is defined as one less the maximum probability of occupancy in a cubic neighborhood centered at the location of the beam detection in the evidence grid 118. Further, in at least one implementation, the matching errors for the possible locations of beam detection can be pre-computed offline and stored for later use in facilitating the quicker evaluation of the cost function. For example, the matching errors for the possible locations of beam detection may be stored in a hash table, such that the matching errors may be directly ported from the hash table when evaluating the cost function. When the cost function is evaluated, a matching error vector may be identified that includes the matching errors from the ranging beams and a Jacobian matrix of the matching error vector with respect to the position and attitude in the navigation solution. To identify the correction for the navigation solution, the navigation processor 104 may solve a normal equation based on the Jacobian matrix and the matching error vector. The resulting correction may then be added to the initial navigation solution 108 to calculate a corrected navigation solution, which is then used as the navigation solution in the subsequent iteration of comparing the current range scan frame 116 to the evidence grid 118. The navigation processor 104 performs subsequent iterations until the magnitude of the matching error vector is less than a threshold.

In certain implementations, the navigation processor 104 performs this process when data is received from the sensor 106. Alternatively, the navigation processor 104 periodically performs the comparison of the current range scan frame 116 to the evidence grid 118. In at least one implementation, the navigation processor 104 periodically performs the comparison based on the environment through which the navigation system 100 is navigating. For example, if the navigation system 100 is navigating through a degraded visual environment, the navigation processor 104 will perform the comparison more frequently than if the navigation system 100 is navigating through an environment offering exceptional situational awareness.

In certain implementations, the current range scan frame 116 may contain data that does not match the evidence grid 118 due to a feature that was scanned by a ranging beam of the sensor 106 that is not represented in the evidence grid 118. For example, the evidence grid 118 may be based on a model of data that only contains bare earth data, or the model that was used to create the evidence grid 118 may be out of date. When the current range scan frame 116 contains data that represents features not represented in the evidence grid 118, the navigation processor 104 may also update the evidence grid 118 to include the feature that was sensed by the sensor 106 and more accurately represent the environment containing the navigation system 100. Further, when the navigation processor 104 updates the evidence grid 118, the navigation processor 104 also updates the possible matching errors for the location of range detection inside the evidence grid 118 that are associated with the newly identified feature. Thus, the navigation system 100 is able to accurately compare the current range scan frame 116 with the data that is stored in the evidence grid 118 to update the navigation solution provided by the navigation system 100.

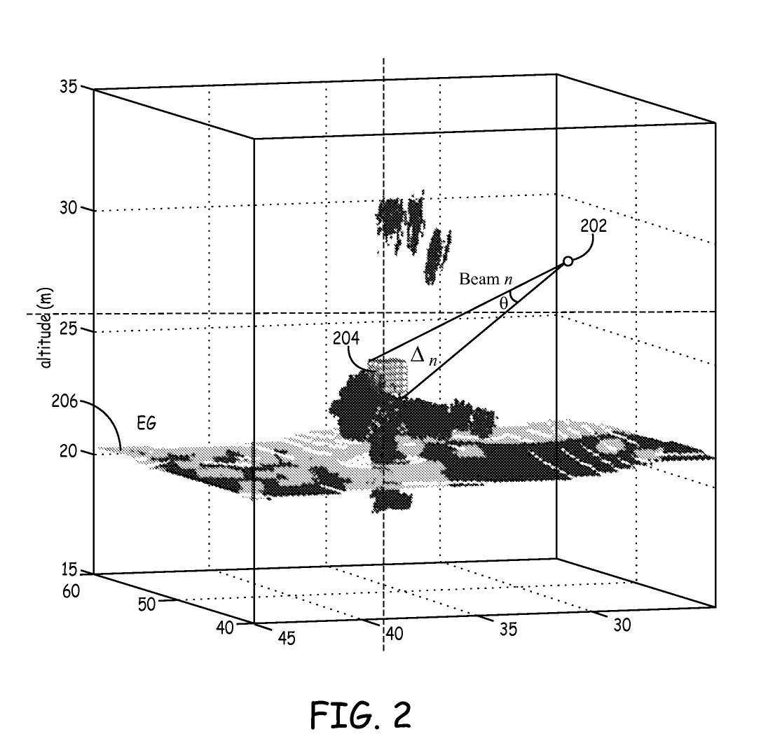

FIG. 2 is an illustration of a graph that illustrates the identification of a cubic neighborhood 204 from data returned from a ranging beam 202 of a sensor, such as sensor 106. As described above, the navigation processor 104 receives data from the sensor 106. In at least one implementation, the data from the sensor includes information associated with individual ranging beams that detect objects. For each ranging beam that detects a feature, the sensor 106 provides a direction αₙ of the beam in the local East-North-Up (ENU) frame, as determined by both the azimuth and elevation of the beam, located at sensor 106 and the range rₙ from the sensor. At the location where the feature is detected, a cubic neighborhood 204 is identified. As illustrated, the cubic neighborhood is defined as a function of the beam width θ and the range rₙ of the feature from the sensor. When the cubic neighborhood 204 is defined, the navigation processor 104 determines the matching error for the beam and the evidence grid 206 according to the following equation:

eₙ(rₙ,αₙ,P,A,EG)=1−max({EGᵥ|vεΔₙ}).

As shown in the above equation, the matching error for a cubic neighborhood 204 and the evidence grid 206 is equal to one less the maximum value for a probability of occupancy for a voxel in the evidence grid 206 that is within the volume associated with the cubic neighborhood 204. For example, if the probability of occupancy is low for all the voxels in the evidence grid 206 that are associated with the cubic neighborhood 204, then the error will be high or close to one. However, if the probability of occupancy is high for at least one voxel in the evidence grid 206 that is associated with the cubic neighborhood 204, then the error will be low or close to zero. Further, as described above, the matching errors for the possible cubic neighborhoods 204 are pre-calculated to facilitate the computation. For example, the matching errors for the possible cubic neighborhoods are stored in a hash table, such that when the cubic neighborhood for a ranging beam 202 is identified, the navigation processor 104 merely identifies the matching error from the hash table that is associated with the cubic neighborhood 204.

In further implementations, to determine navigational adjustments that may be made to the navigation solution, the navigation processor calculates a cost function for the multiple beams that scan the environment from the sensor 106 according to the following equation:

$$C ( P , A ) = {‖ e ‖}^{2} = {\sum }_{n = 1}^{N} {e}_{n}^{2} ( {r}_{n} , {α}_{n} , P , A , EG ) .$$

As shown, in the above equation, the cost function equals the sum of squared matching errors for the N beams that scanned the environment. When the cost function is calculated, the navigation processor 104 translates and/or rotates the evidence grid 118 and/or current range scan frame 116 to reduce the cost function. In certain implementations, the navigation processor 104 adjusts the current range scan frame 116 in relation to the evidence grid 118 until the cost function is minimized. When the cost function is reduced or minimized, the navigation processor 104 then calculates position and attitude adjustments to the navigation solution using the position and attitude of the sensor 106, current range scan frame 116, and Jacobian matrix, where the Jacobian matrix is represented by the following equation:

$$J = ( \begin{matrix}\frac{\partial {e}_{1}}{\partial P} & \frac{\partial {e}_{1}}{\partial A} \\ ⋮ & ⋮ \\ \frac{\partial {e}_{N}}{\partial P} & \frac{\partial {e}_{N}}{\partial A}\end{matrix} ) .$$

The Jacobian matrix can be used to solve for the position and attitude adjustments to the navigation solution as illustrated by the following equation:

$$( {J}^{T} J + λ diag ( {J}^{T} J ) ) ( \begin{matrix}Δ P \\ Δ A\end{matrix} ) = - {J}^{T} e$$

When the position and attitude adjustments are calculated, the position and attitude adjustments may be added to the navigation solution to create an updated navigation solution, as shown in the following equation:

$$( \begin{matrix}{P}^{( i + 1 )} \\ {A}^{( i + 1 )}\end{matrix} ) = ( \begin{matrix}{P}^{( i )} \\ {A}^{( i )}\end{matrix} ) + ( \begin{matrix}Δ P \\ Δ A\end{matrix} ) .$$

The updated navigation solution may be used in subsequent iterations for comparing a current range scan frame 116 with an evidence grid 118 to identify future position and attitude updates for the updated navigation solution.

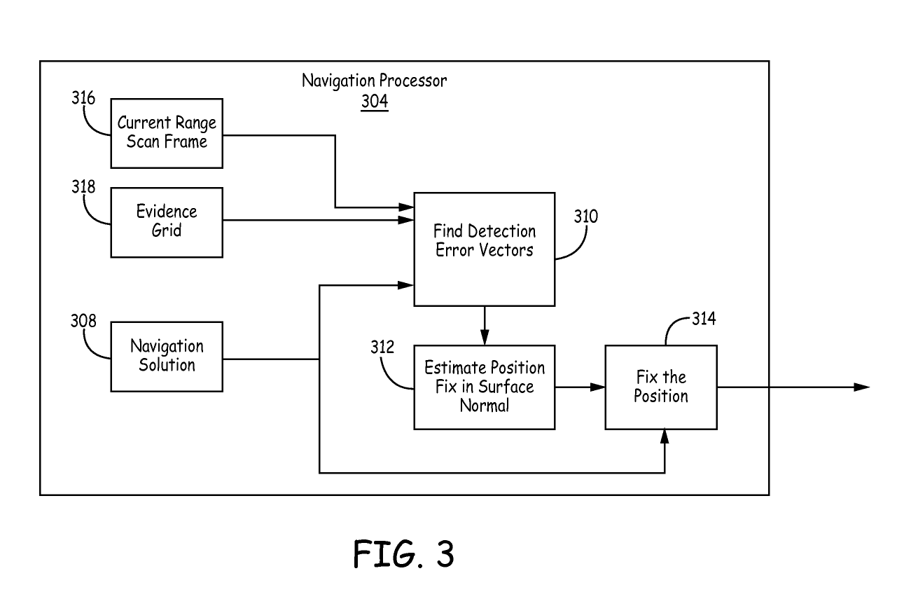

FIG. 3 is a block diagram illustrating the adjustment of the identified position of a sensor by a navigation processor 304. In at least one implementation, navigation processor 304 is part of navigation processor 104 in FIG. 1 and defines additional functionality that may be performed by navigation processor 104. To adjust the position of the sensor, the navigation processor 304 uses a current range scan frame 316, an evidence grid 318, and a navigation solution 308. In at least one implementation, the current range scan frame 316, the evidence grid 318, and the navigation solution 308 are created as respectively described above in regards to the current range scan frame 116, the evidence grid 118, and the navigation solution 108.

In certain embodiments, the identified position of the sensor includes position data that the navigation processor 304 uses to identify the location of items within the current range scan frame 316 when calculating navigation solution updates as described above in relation to FIGS. 1 and 2. However, when the system is initially run, navigation errors may cause the data in the current range scan frame 316 and the evidence grid 318 to not overlap at all, which lack of overlap increases the difficulty of calculating navigation solution updates as described above. To reduce the initial navigation errors, the navigation processor 304 computes an adjustment for the identified position of the sensor along the normal of the dominant three dimensional surface structure of the evidence grid 318. The adjustment of the identified position roughly aligns the current range scan frame 316 with the evidence grid 318.

To identify the adjustment for the identified position, the navigation processor 304 finds detection error vectors at 310. For example, the navigation processor 304 identifies the nearest intersection of the ranging beams from the sensor (such as sensor 106 in FIG. 1) described in the current range scan frame 316 with occupied voxels in the evidence grid 318. To identify the intersections, the ranging beams are traced across the evidence grid according to the initial navigation solution and the direction of the ranging beams. The nearest occupied voxel within the ranging beam is identified as the nearest intersection. When the nearest intersection is identified, the navigation processor calculates displacement vectors from the locations of the range detections in the current range scan frame 316 to the associated identified nearest intersection in the evidence grid 318. When the data in current range scan frame 316 and the evidence grid 318 are aligned, the identified nearest intersections coincide with the location of the range detections. However, as stated above, due to an initial navigation error, a displacement vector separates the range detections from the nearest intersections in the evidence grid 318.

In at least one further implementation, the navigation processor 304 estimates a position adjustment at 312. To estimate the position adjustment, the navigation processor 304 computes the projection of the displacement vector onto the surface normal at the corresponding intersection location and takes the projected component of the displacement vector as the adjustment for the identified position for the corresponding beam. As there are multiple beams, the navigation processor 304 combines the calculated adjustments from the multiple beams to determine an adjustment for the identified position for the current range scan frame 316. For example, the navigation processor 304 identifies the median adjustment from the different beams as the adjustment for the current range scan frame 316. Alternatively, the navigation processor 304 may identify the average adjustment for all the beams as the adjustment for the current range scan frame 316.

When the adjustment to the identified position is determined, the navigation processor 304 then applies the position adjustment at 314. To apply the adjustment to the identified position, the navigation processor 304 may add the adjustment to the measurements from all the beams that are used to produce the current range scan frame 316. When the adjustment is added to the measurements from the beams used by the sensor, the data in the current range scan frame 316 and the evidence grid 318 are roughly aligned. In certain implementations, the navigation processor 304 performs the position fixing during any initialization processes of a navigation system. Alternatively, the navigation processor 304 periodically performs the position fixing.

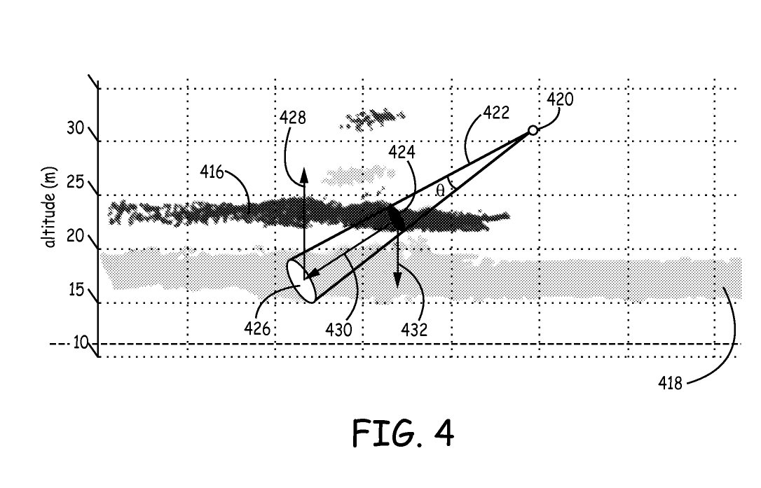

FIG. 4 is a graph representing a current range scan frame 416 and an evidence grid 418 that provides a visual illustration on how to calculate the adjustment for an identified position of a sensor 420. As described above, the sensor 420 emits a ranging beam 422 to scan an environment. At times, when the environment is scanned, the sensor 420 may be subject to a series of position errors that can cause the current range scan frame 416 to not align with the evidence grid 418. When the current range scan frame 416 and the evidence grid 418 are not aligned with one another, the ability of a navigation processor to match the current range scan frame 416 to the evidence grid 418 significantly decreases. To align the current range scan frame 416 with the evidence grid 418, a navigation processor identifies an evidence grid intersection 426. The evidence grid intersection 426 is the nearest occupied voxels to the sensor 420 that are intersected by a ranging beam 422. When the evidence grid intersection 426 is identified, the navigation processor then identifies a range detection 424 and a displacement vector 430. The range detection 424 may be the surface that was detected by the beam 422 in relation to the sensor 420. And the displacement vector 430 may be the vector that extends from the range detection 424 to the evidence grid intersection 426.

To calculate the adjustment to the identified position of the sensor, a navigation processor identifies a normal vector 428 that is normal to a surface of the evidence grid 418. In one implementation, the normal vector 428 is normal to the dominant surface of the evidence grid 418 at the evidence grid intersection 426. In an alternative implementation, the normal vector 428 is normal to the dominant surface of the evidence grid 418 over the area that is intersected by multiple ranging beams 422 from sensor 420. Further, the normal vector 428 may be normal to the dominant surface of the evidence grid 418 over a evidence grid neighborhood identified by the navigation processor. When the normal vector 428 is identified, the navigation processor projects the displacement vector 430 onto the normal vector 428 to determine the component of the displacement vector 430 that is aligned with the normal vector 428. The component of the displacement vector 430 that is aligned with the normal vector 428 is then identified as the adjustment 432 to the identified position of the sensor 420 for the associated ranging beam 422. When all the adjustments 432 are calculated for the multiple ranging beams 422 of the sensor 420, the navigation processor may identify the median adjustment 432 from the multiple adjustments from the multiple ranging beams 422 and adjust the position of the sensor by the median adjustment 432. When the position of the sensor 420 is adjusted, the range detections 424 and the evidence grid intersection 426 may be roughly aligned, which alignment facilitates the comparison of the current range scan frame with the evidence grid as described above in relation to FIGS. 1 and 2.

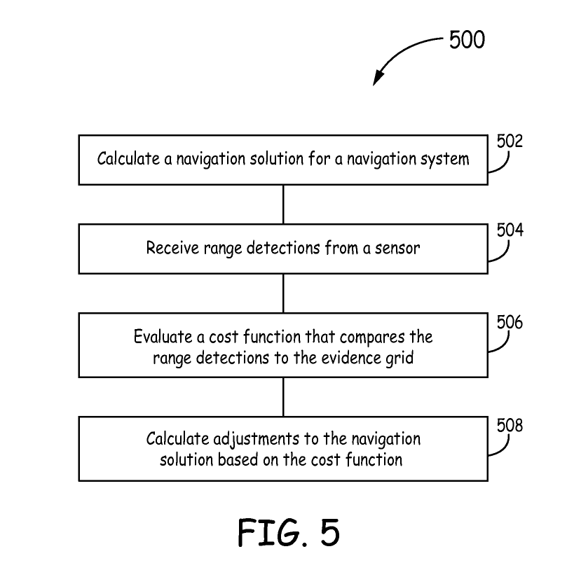

FIG. 5 is a flow diagram of a method 500 for comparing an evidence grid to range data received from a range sensor. Method 500 proceeds at 502, where a navigation solution is calculated for a navigation system. For example, the navigation system may receive inertial measurements from an inertial measurement unit and calculate the navigation solution for the navigation system based on a previously calculated navigation solution and the recently received inertial measurements. Method 500 also proceeds at 504, where range detections are received from a sensor. For example, a range sensor scans an environment with multiple beams that detect objects within the environment of the navigation solution.

Method 500 proceeds at 506, where a cost function is evaluated that compares the range detections to the evidence grid. To evaluate the cost function, a navigation processor identifies a range detection that identifies a surface at a particular range and direction from an identified location of the sensor. The navigation processor then defines a cubic neighborhood centered at the location of the range detection and identifies the voxels in the evidence grid that are associated with the region encompassed by the cubic neighborhood. When the voxels associated with the cubic neighborhood are identified, the navigation processor identifies a voxel in the voxels that are associated with the cubic neighborhood. The navigation processor then calculates a matching error for the identified voxel by subtracting the probability of occupancy for the voxel from one. Further, the navigation processor then calculates matching errors associated with each range detection detected by a sensor. Method 500 proceeds at 508 where adjustments to the navigation solution are calculated based on the cost function. For example, the navigation processor identifies a position and attitude adjustment that reduces the sum of the calculated matching errors associated with the range detections. The position and attitude adjustments are then added to the navigation solution to update the navigation solution and compensate for accumulated errors. Thus, the navigation processor is able to compare range data to an evidence grid to calculate updates for the navigation solution.

### EXAMPLE EMBODIMENTS

Example 1 includes a navigation system, the system comprising: an inertial measurement unit configured to provide inertial measurements; a sensor configured to provide range detections based on scans of an environment containing the navigation system; and a navigation processor configured to provide a navigation solution, wherein the navigation processor is coupled to receive the inertial measurements from the inertial measurement unit and the range measurements from the sensor, wherein computer readable instructions direct the navigation processor to: identify a portion of an evidence grid based on the navigation solution; compare the range detections with the portion of the evidence grid; and calculate adjustments to the navigation solution based on the comparison of the range detections with the portion of the evidence grid to compensate for errors in the inertial measurement unit.

Example 2 includes the navigation system of Example 1, wherein identifying a portion of an evidence grid comprises: identifying the data in the evidence grid associated with a position described in the navigation solution; and identifying an evidence grid neighborhood, wherein the evidence grid neighborhood comprises voxels representing an area that is within a predetermined range of the position of the navigation solution.

Example 3 includes the navigation system of any of Examples 1-2, wherein comparing the range detections with the portion of the evidence grid comprises: receiving at least one range detection in the range detections, wherein each of the at least one range detections comprise a range and a direction of a sensed surface from an identified location of the sensor; defining at least one cubic neighborhood centered at the location of the at least one range detection; identifying at least one voxel in the portion of the evidence grid associated with the location of each of the at least one cubic neighborhoods; identifying a probability of occupancy of each voxel in the at least one voxels; and comparing the probability of occupancy to the location of the associated cubic neighborhood.

Example 4 includes the navigation system of Example 3, wherein comparing the probability of occupancy to the location of the associated cubic neighborhood comprises: identifying a voxel in the at least one voxels having the highest probability of occupancy; calculating a squared matching error based on the probability of occupancy for the voxel; and associating the squared matching error with the associated cubic neighborhood.

Example 5 includes the navigation system of Example 4, wherein the squared matching error for possible location of cubic neighborhoods is stored in a data structure, and calculating the squared matching error comprises accessing the squared matching error stored in the data structure that is linked with the location of the associated cubic neighborhood.

Example 6 includes the navigation system of any of Examples 4-5, wherein calculating adjustments to the navigation solution to compensate for errors in the inertial measurement unit comprises: identifying a position adjustment and an attitude adjustment that reduces a sum of squared matching errors for the at least one cubic neighborhoods; and adding the position adjustment and the attitude adjustment to the navigation solution.

Example 7 includes the navigation system of Example 6, wherein identifying a position adjustment and an attitude adjustment comprises using a normal equation and a Jacobian matrix to determine the position adjustment and the attitude adjustment.

Example 8 includes the navigation system of any of Examples 1-7, wherein the computer readable instructions further direct the navigation processor to calculate an adjustment for an identified position of the sensor.

Example 9 includes the navigation system of Example 8, wherein calculating the adjustment for the identified position of the sensor comprises: estimating a beam adjustment for the identified position of the sensor along a normal axis for each of at least one beams produced by the sensor in acquiring the range measurements, wherein the normal axis is normal to a dominant surface of the evidence grid; combining each beam adjustment for the at least one beams to identify the adjustment for the identified position of the sensor; and adding the adjustment to the identified position of the sensor.

Example 10 includes the navigation system of Example 9, wherein estimating the beam adjustment comprises: identifying an evidence grid intersection that indicates where a beam from the sensor at a defined direction would intersect with terrain as indicated by the evidence grid at the identified position of the sensor; identifying a beam detection in the range detections, where the beam detection indicates a range and a direction of a sensed surface from an identified location of the sensor; identifying a displacement vector that identifies the distance and direction from the beam detection to the evidence grid intersection; calculating the beam adjustment, wherein the beam adjustment equals the component of the displacement vector along the normal axis.

Example 11 includes the navigation system of any of Examples 1-10, wherein range detections that are not represented by an associated feature in the evidence grid are added to the evidence grid.

Example 12 includes the navigation system of any of Examples 1-11, wherein the navigation processor iteratively compares the range detections with the portion of the evidence grid until at least one stopping criteria is achieved.

Example 13 includes a method for comparing an evidence grid and range data, the method comprising: calculating a navigation solution for a navigation system; receiving range detections from a sensor, wherein the sensor provides the range detections based on scans of an environment containing the navigation system; evaluating a cost function that compares the range detections to the evidence grid; calculating adjustments to the navigation solution based on the cost function.

Example 14 includes the method of Example 13, wherein evaluating the cost function that compares the range detections to the evidence grid comprises: identifying at least one range detection in the range detections, wherein each of the at least one range detections comprise a range and a direction of a sensed surface from an identified location of the sensor; defining at least one cubic neighborhood centered at a location of the at least one range detection; identifying at least one voxel in the portion of the evidence grid associated with a location of each of the at least one cubic neighborhoods; identifying a probability of occupancy of each voxel in the at least one voxels; and comparing the probability of occupancy to the location of the associated cubic neighborhood.

Example 15 includes the method of Example 14, wherein comparing the probability of occupancy to the location of the associated cubic neighborhood comprises: identifying a voxel in the at least one voxels having the highest probability of occupancy; calculating a squared matching error based on the probability of occupancy for the voxel; and associating the squared matching error with the associated cubic neighborhood.

Example 16 includes the method of Example 15, wherein calculating adjustments to the navigation solution based on the cost function comprises: identifying a position adjustment and an attitude adjustment that reduces a sum of squared matching errors for the at least one cubic neighborhoods; and adding the position adjustment and the attitude adjustment to the navigation solution.

Example 17 includes the method of any of Examples 13-16, wherein the computer readable instructions further direct the navigation processor to calculate an adjustment for an identified position of the sensor.

Example 18 includes the method of Example 17, wherein calculating the adjustment for the identified position of the sensor comprises: estimating a beam adjustment for the identified position of the sensor along a normal axis for each of at least one beams produced by the sensor in acquiring the range measurements, wherein the normal axis is normal to a dominant surface of the evidence grid; combining each beam adjustment for the at least one beams to identify the adjustment for the identified position of the sensor; and adding the adjustment to the identified position of the sensor.

Example 19 includes the method of Example 18, wherein estimating the beam adjustment comprises: identifying an evidence grid intersection that indicates where a beam from the sensor at a defined direction would intersect with terrain as indicated by the evidence grid at the identified position of the sensor; identifying a beam detection in the range detections, where the beam detection indicates a range and a direction of a sensed surface from an identified location of the sensor; identifying a displacement vector that identifies the distance and direction from the beam detection to the evidence grid intersection; calculating the beam adjustment, wherein the beam adjustment equals the component of the displacement vector along the normal axis.

Example 20 includes a navigation system, the system comprising: an inertial measurement unit configured to provide inertial measurements; a sensor configured to provide range detections based on scans of an environment containing the navigation system; and a navigation processor configured to provide a navigation solution, wherein the navigation processor is coupled to receive the inertial measurements from the inertial measurement unit and the range measurements from the sensor, wherein computer readable instructions direct the navigation processor to: identify a portion of an evidence grid based on the navigation solution; receive at least one range detection from the sensor, wherein each of the at least one range detections comprise a range and a direction of a sensed surface from an identified location of the sensor; define at least one cubic neighborhood centered at the location of the at least one range detection; identify at least one voxel in the portion of the evidence grid associated with the location of each of the at least one cubic neighborhoods; identify a probability of occupancy of each voxel in the at least one voxels; compare the probability of occupancy to the location of the associated cubic neighborhood; calculate adjustments to the navigation solution based on the comparison of the probability of occupancy to the location of the associated cubic neighborhood; and update the navigation solution based on the calculated adjustments.

Although specific embodiments have been illustrated and described herein, it will be appreciated by those of ordinary skill in the art that any arrangement, which is calculated to achieve the same purpose, may be substituted for the specific embodiments shown. Therefore, it is manifestly intended that this invention be limited only by the claims and the equivalents thereof.

What is claimed is:

1. A navigation system, the system comprising:
an inertial measurement unit configured to provide inertial measurements;
a sensor configured to provide range detections based on scans of an environment containing the navigation system; and
a navigation processor configured to provide a navigation solution, wherein the navigation processor is coupled to receive the inertial measurements from the inertial measurement unit and the range measurements from the sensor, wherein computer readable instructions direct the navigation processor to:
identify a portion of an evidence grid based on the navigation solution;
compare the range detections with the portion of the evidence grid; and
calculate adjustments to the navigation solution based on the comparison of the range detections with the portion of the evidence grid to compensate for errors in the inertial measurement unit.

2. The navigation system of claim 1, wherein identifying a portion of an evidence grid comprises:
identifying the data in the evidence grid associated with a position described in the navigation solution; and
identifying an evidence grid neighborhood, wherein the evidence grid neighborhood comprises voxels representing an area that is within a predetermined range of the position of the navigation solution.

3. The navigation system of claim 1, wherein comparing the range detections with the portion of the evidence grid comprises:
receiving at least one range detection in the range detections, wherein each of the at least one range detections comprise a range and a direction of a sensed surface from an identified location of the sensor;
defining at least one cubic neighborhood centered at the location of the at least one range detection;
identifying at least one voxel in the portion of the evidence grid associated with the location of each of the at least one cubic neighborhoods;
identifying a probability of occupancy of each voxel in the at least one voxels; and
comparing the probability of occupancy to the location of the associated cubic neighborhood.

4. The navigation system of claim 3, wherein comparing the probability of occupancy to the location of the associated cubic neighborhood comprises:
identifying a voxel in the at least one voxels having the highest probability of occupancy;
calculating a squared matching error based on the probability of occupancy for the voxel; and
associating the squared matching error with the associated cubic neighborhood.

5. The navigation system of claim 4, wherein the squared matching error for possible location of cubic neighborhoods is stored in a data structure, and calculating the squared matching error comprises accessing the squared matching error stored in the data structure that is linked with the location of the associated cubic neighborhood.

6. The navigation system of claim 4, wherein calculating adjustments to the navigation solution to compensate for errors in the inertial measurement unit comprises:
identifying a position adjustment and an attitude adjustment that reduces a sum of squared matching errors for the at least one cubic neighborhoods; and
adding the position adjustment and the attitude adjustment to the navigation solution.

7. The navigation system of claim 6, wherein identifying a position adjustment and an attitude adjustment comprises using a normal equation and a Jacobian matrix to determine the position adjustment and the attitude adjustment.

8. The navigation system of claim 1, wherein the computer readable instructions further direct the navigation processor to calculate an adjustment for an identified position of the sensor.

9. The navigation system of claim 8, wherein calculating the adjustment for the identified position of the sensor comprises:
estimating a beam adjustment for the identified position of the sensor along a normal axis for each of at least one beams produced by the sensor in acquiring the range measurements, wherein the normal axis is normal to a dominant surface of the evidence grid;
combining each beam adjustment for the at least one beams to identify the adjustment for the identified position of the sensor; and
adding the adjustment to the identified position of the sensor.

10. The navigation system of claim 9, wherein estimating the beam adjustment comprises:
identifying an evidence grid intersection that indicates where a beam from the sensor at a defined direction would intersect with terrain as indicated by the evidence grid at the identified position of the sensor;
identifying a beam detection in the range detections, where the beam detection indicates a range and a direction of a sensed surface from an identified location of the sensor;
identifying a displacement vector that identifies the distance and direction from the beam detection to the evidence grid intersection;
calculating the beam adjustment, wherein the beam adjustment equals the component of the displacement vector along the normal axis.

11. The navigation system of claim 1, wherein range detections that are not represented by an associated feature in the evidence grid are added to the evidence grid.

12. The navigation system of claim 1, wherein the navigation processor iteratively compares the range detections with the portion of the evidence grid until at least one stopping criteria is achieved.

13. A method for comparing an evidence grid and range data, the method comprising:
calculating a navigation solution for a navigation system;
receiving range detections from a sensor, wherein the sensor provides the range detections based on scans of an environment containing the navigation system;
evaluating a cost function that compares the range detections to the evidence grid;
calculating adjustments to the navigation solution based on the cost function.

14. The method of claim 13, wherein evaluating the cost function that compares the range detections to the evidence grid comprises:
identifying at least one range detection in the range detections, wherein each of the at least one range detections comprise a range and a direction of a sensed surface from an identified location of the sensor;
defining at least one cubic neighborhood centered at a location of the at least one range detection;
identifying at least one voxel in the portion of the evidence grid associated with a location of each of the at least one cubic neighborhoods;
identifying a probability of occupancy of each voxel in the at least one voxels; and
comparing the probability of occupancy to the location of the associated cubic neighborhood.

15. The method of claim 14, wherein comparing the probability of occupancy to the location of the associated cubic neighborhood comprises:
identifying a voxel in the at least one voxels having the highest probability of occupancy;
calculating a squared matching error based on the probability of occupancy for the voxel; and
associating the squared matching error with the associated cubic neighborhood.

16. The method of claim 15, wherein calculating adjustments to the navigation solution based on the cost function comprises:
identifying a position adjustment and an attitude adjustment that reduces a sum of squared matching errors for the at least one cubic neighborhoods; and
adding the position adjustment and the attitude adjustment to the navigation solution.

17. The method of claim 13, wherein the computer readable instructions further direct the navigation processor to calculate an adjustment for an identified position of the sensor.

18. The method of claim 17, wherein calculating the adjustment for the identified position of the sensor comprises:
estimating a beam adjustment for the identified position of the sensor along a normal axis for each of at least one beams produced by the sensor in acquiring the range measurements, wherein the normal axis is normal to a dominant surface of the evidence grid;
combining each beam adjustment for the at least one beams to identify the adjustment for the identified position of the sensor; and
adding the adjustment to the identified position of the sensor.

19. The method of claim 18, wherein estimating the beam adjustment comprises:
identifying an evidence grid intersection that indicates where a beam from the sensor at a defined direction would intersect with terrain as indicated by the evidence grid at the identified position of the sensor;
identifying a beam detection in the range detections, where the beam detection indicates a range and a direction of a sensed surface from an identified location of the sensor;
identifying a displacement vector that identifies the distance and direction from the beam detection to the evidence grid intersection;
calculating the beam adjustment, wherein the beam adjustment equals the component of the displacement vector along the normal axis.

20. A navigation system, the system comprising:
an inertial measurement unit configured to provide inertial measurements;
a sensor configured to provide range detections based on scans of an environment containing the navigation system; and
a navigation processor configured to provide a navigation solution, wherein the navigation processor is coupled to receive the inertial measurements from the inertial measurement unit and the range measurements from the sensor, wherein computer readable instructions direct the navigation processor to:
identify a portion of an evidence grid based on the navigation solution;
receive at least one range detection from the sensor, wherein each of the at least one range detections comprise a range and a direction of a sensed surface from an identified location of the sensor;
define at least one cubic neighborhood centered at the location of the at least one range detection;
identify at least one voxel in the portion of the evidence grid associated with the location of each of the at least one cubic neighborhoods;
identify a probability of occupancy of each voxel in the at least one voxels;
compare the probability of occupancy to the location of the associated cubic neighborhood;
calculate adjustments to the navigation solution based on the comparison of the probability of occupancy to the location of the associated cubic neighborhood; and
update the navigation solution based on the calculated adjustments.
